(19) United States
(12) Patent Application Publication
(10) Pub. No.: US 2026/0274333 A1
(43) Pub. Date: Sep. 17, 2026

(54) DRIVING CONTROL APPARATUS

(71) Applicant: Honda Motor Co., Ltd., Tokyo (JP)

(72) Inventors: Ayana Kuribara, Tokyo (JP); Yuki Imanishi, Tokyo (JP); Yoshinori Izumi, Tokyo (JP); Fumiya Morosawa, Tokyo (JP)

(21) Appl. No.: 19/560,016

(22) Filed: Mar. 7, 2026

(30) Foreign Application Priority Data
Mar. 12, 2025 (JP) 2025-039657

(51) Int. Cl. B62D 6/00

(52) U.S. Cl. CPC B62D 6/001

(57) ABSTRACT

A driving control apparatus includes a microprocessor and a memory connected to the microprocessor. The microprocessor is configured to perform: comparing a target operation value of a predetermined operation of a moving body with an actual operation value, calculating a command value used for controlling the operation so as to bring the actual operation value closer to the target operation value, and controlling the operation based on the command value. The microprocessor is configured to further perform: calculating a corrected target operation value by correcting the target operation value using an assist component of an assist function in which manual operation for the operation by an occupant is assisted, and comparing the corrected target operation value with the actual operation value to calculate the command value.

### CROSS-REFERENCE TO RELATED APPLICATION

This application is based upon and claims the benefit of priority from Japanese Patent Application No. 2025-039657 filed on March 12, 2025, the content of which is incorporated herein by reference.

### BACKGROUND

### Technical Field

The present disclosure relates to a driving control apparatus for controlling vehicle driving.

### Related Art

In recent years, there is a demand for a vehicle control system that leads to improvement in traffic safety and that contributes to development of a sustainable transportation system. As this type of device, there has been conventionally known a device having a function of automatically conducting steering control so that a target steering angle generated, based on a signal from a camera or the like, matches an actual steering angle, and a function of conducting steering assist control so as to assist steering torque (see, for example, Japanese Patent No. 6245258). The device described in Japanese Patent No. 6245258, focusing on control outputs that interfere with each other at the time of switching between the automatic steering control and the assist control and cause an unintended vehicle behavior, compensates the target steering angle to suppress the control output in the automatic steering control when switching from the automatic steering control to the assist control.

However, by only compensating the target steering angle as in the device described in Japanese Patent No. 6245258, it is not possible to sufficiently suppress the unintended vehicle behavior as described above when the target steering angle itself is insufficient in accuracy.

### SUMMARY

An aspect of the present invention is a driving control apparatus including a microprocessor and a memory connected to the microprocessor. The microprocessor is configured to perform: comparing a target operation value of a predetermined operation of a moving body with an actual operation value, calculating a command value used for controlling the operation so as to bring the actual operation value closer to the target operation value, and controlling the operation based on the command value. The microprocessor is configured to further perform: calculating a corrected target operation value by correcting the target operation value using an assist component of an assist function in which manual operation for the operation by an occupant is assisted, and comparing the corrected target operation value with the actual operation value to calculate the command value.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an overall configuration of a vehicle control system of a subject vehicle including a driving control apparatus according to an embodiment of the present invention;

FIG. 2A is a diagram illustrating a rapid change in assist output;

FIG. 2B is a diagram illustrating the rapid change in assist output;

FIG. 3 is a block diagram of a configuration of main components of the driving control apparatus according to the present embodiment;

FIG. 4 is a diagram for describing a system configuration of the driving control apparatus;

FIG. 5 is a diagram for describing compensation of a target steering torque by the target value compensation unit of FIG. 3:

FIG. 6A is a diagram illustrating an example of a ratio map;

FIG. 6B is a diagram illustrating another example of a ratio map;

FIG. 6C is a diagram illustrating another example of a ratio map; and

FIG. 7 is a flowchart illustrating an example of processing performed by a CPU of the controller of FIG. 4.

### DETAILED DESCRIPTION

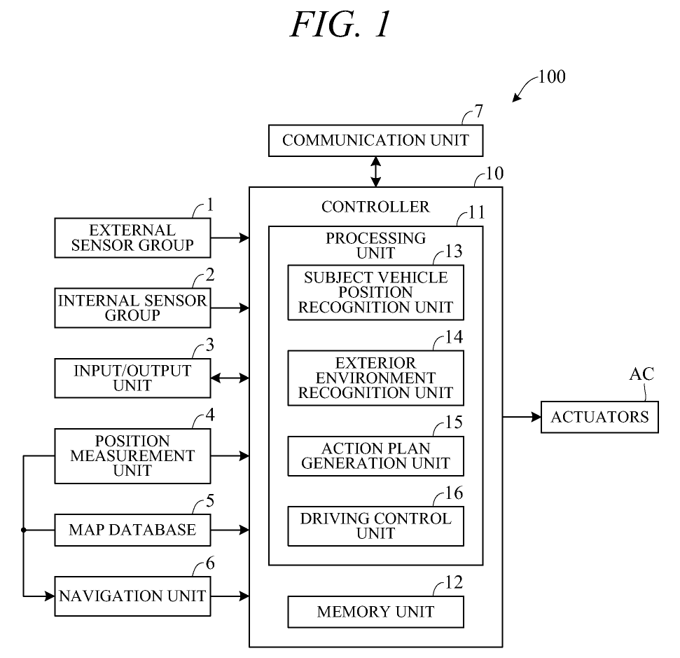

Hereinafter, embodiments of the present invention will be described with reference to FIGS. 1 to 7. A driving control apparatus according to an embodiment of the present invention is applicable to, for example, a vehicle having a self-driving capability, that is, a self-driving vehicle. Note that the driving control apparatus according to an embodiment of the present invention is applicable to both a manual driving vehicle having a driving assist capability and a self-driving vehicle. However, hereinafter, for convenience of description, a case where the driving control apparatus is applied to the self-driving vehicle will be given as an example. Note that a vehicle on which the driving control apparatus according to the present embodiment is mounted will be referred to as a subject vehicle in order to be distinguished from other vehicles, in some cases. The subject vehicle may be any of an engine vehicle having an internal combustion engine (engine) as a driving power source, an electric vehicle having a driving motor as a driving power source, and a hybrid vehicle having an engine and a driving motor as a driving power source. The subject vehicle is capable of driving not only in a self-drive mode that does not necessitate a driver’s driving operation but also in a manual drive mode that necessitates a driver’s driving operation.

First, a schematic configuration of the subject vehicle related to self-driving will be described. FIG. 1 is a block diagram schematically illustrating an overall configuration of a vehicle control system 100 of a subject vehicle including a driving control apparatus according to an embodiment of the present invention. As illustrated in FIG. 1, the vehicle control system 100 mainly includes a controller 10, an external sensor group 1, an internal sensor group 2, an input/output device 3, a position measurement unit 4, a map database 5, a navigation unit 6, a communication unit 7, and a traveling actuator AC, each of which is communicably connected with the controller 10.

The external sensor group 1 is a generic term for a plurality of sensors (external sensors) that detect an external situation which is peripheral information of the subject vehicle. For example, the external sensor group 1 includes a LiDAR that measures scattered light with respect to irradiation light in all directions of the subject vehicle and measures a distance from the subject vehicle to a surrounding obstacle, a radar that detects other vehicles, obstacles, and the like in the surroundings of the subject vehicle by irradiating with electromagnetic waves and detecting reflected waves, and a camera that is mounted on the subject vehicle, that has an imaging element such as a charge coupled device (CCD) or a complementary metal oxide semiconductor (CMOS), and that captures images of the surroundings (front, rear, and side) of the subject vehicle.

The internal sensor group 2 is a generic term for a plurality of sensors (internal sensors) that detect a driving state of the subject vehicle. For example, the internal sensor group 2 includes a vehicle speed sensor that detects a vehicle speed of the subject vehicle, an acceleration sensor that detects acceleration in a front-rear direction of the subject vehicle and acceleration in a left-right direction (lateral acceleration) of the subject vehicle, a rotation speed sensor that detects the number of rotations of the driving power source, and a yaw rate sensor that detects a rotation angular speed around a vertical axis of the center of gravity of the subject vehicle. The internal sensor group 2 also includes a steering angle sensor that detects a rotation angle (a steering angle) of a steering shaft coupled to the steering wheel, a steering angular velocity sensor that detects a rotation angular velocity (a steering angular velocity) of the steering shaft, and the like. The internal sensor group 2 also includes a sensor that detects a driver’s driving operation in the manual drive mode, for example, an operation on an accelerator pedal, an operation on a brake pedal, an operation on a steering wheel, and the like.

The input/output device 3 is a generic term for devices in which a command is input from a driver or information is output to the driver. For example, the input/output device 3 includes various switches into which the driver inputs various commands by operating an operation member, a microphone into which the driver inputs a command by voice, a display that provides the driver with information via a display image, and a speaker that provides the driver with information by sound.

The position measurement unit (a GNSS unit) 4 includes a positioning sensor that receives a signal for positioning, transmitted from a positioning satellite. The positioning satellite is an artificial satellite such as a global positioning system (GPS) satellite or a quasi-zenith satellite. The position measurement unit 4 uses positioning information received by the positioning sensor to measure a current position (latitude, longitude, and altitude) of the subject vehicle.

The map database 5 is a device that stores general map information used for the navigation unit 6, and includes, for example, a magnetic disk or a semiconductor element. The map information includes position information of roads, information of road shapes (curvatures or the like), and position information of intersections and branch points. The map information stored in the map database 5 is different from high-precision map information stored in a memory unit 12 of the controller 10.

The navigation unit 6 is a device that searches for a target route on a road to a destination that has been input by a driver, and that provides guidance along the target route. The input of the destination and the guidance along the target route are made via the input/output device 3. The target route is calculated, based on a current position of the subject vehicle that has been measured by the position measurement unit 4 and the map information stored in the map database 5. The current position of the subject vehicle can be measured using the detection values of the external sensor group 1, and the target route may be calculated, based on the current position and the high-precision map information stored in the memory unit 12.

The communication unit 7 communicates with various servers, not illustrated, through a network including a wireless communication network represented by the Internet network, a mobile telephone network, or the like, and acquires map information, driving history information, traffic information, and the like from the servers regularly or at any timing. Driving history information of the subject vehicle may be transmitted to the server via the communication unit 7 in addition to the acquisition of the driving history information. The network includes not only a public wireless communication network but also a closed communication network provided for every predetermined management area, for example, a wireless LAN, Wi-Fi (registered trademark), Bluetooth (registered trademark), and the like. The acquired map information is output to the map database 5 and the memory unit 12, and the map information is updated.

The actuator AC is a traveling actuator for controlling traveling of the subject vehicle. In a case where the driving power source is an engine, the actuator AC includes a throttle actuator that adjusts an opening degree (a throttle opening degree) of a throttle valve of the engine. In a case where the driving power source is a traveling motor, the traveling motor is included in the actuator AC. The actuator AC also includes a brake actuator that operates a braking device of the subject vehicle, a steering actuator that drives the steering device, and a rudder actuator that drives a rudder device.

The controller 10 includes an electronic control unit (ECU). More specifically, the controller 10 is configured with a computer including a processing unit 11 such as a CPU (a microprocessor), the memory unit 12 such as a ROM and a RAM, and other peripheral circuits, not illustrated, such as an I/O interface. Note that although a plurality of ECUs having different functions such as an engine control ECU, a driving motor control ECU, and a braking device ECU can be separately provided, in FIG. 1, the controller 10 is illustrated as a set of these ECUs for convenience.

The memory unit 12 stores high-precision and detailed road map information for automated traveling. The road map information includes road position information, information of a road shape (curvature or the like), information of a road gradient, position information of an intersection or a branch point, information of a type and a position of a division line such as a white line, information of the number of lanes, a lane width and position information for every lane (information of a center position of a lane or a boundary line of a lane position), position information of a landmark (a traffic light, a sign, a building, or the like) as a mark on a map, and information of a road surface profile such as unevenness of a road surface. The map information stored in the memory unit 12 may include map information that has been acquired from the outside of the subject vehicle via the communication unit 7, or may include map information created by the subject vehicle itself using detection values of the external sensor group 1 or detection values of the external sensor group 1 and the internal sensor group 2. The memory unit 12 also stores information of various control programs and thresholds for use in the programs.

The processing unit 11 includes a subject vehicle position recognition unit 13, an exterior environment recognition unit 14, an action plan generation unit 15, and a driving control unit 16 as functional configurations.

The subject vehicle position recognition unit 13 recognizes a position of the subject vehicle (a subject vehicle position) on a map, based on the position information of the subject vehicle obtained by the position measurement unit 4 and the map information of the map database 5. The subject vehicle position may be recognized using the map information stored in the memory unit 12 and the surrounding information of the subject vehicle that has been detected by the external sensor group 1, and thus it becomes possible to recognize the subject vehicle position with high accuracy. The movement information (a moving direction and a moving distance) of the subject vehicle may be calculated, based on the detection values of the internal sensor group 2, and thus the subject vehicle position can also be recognized. Note that when the subject vehicle position is measurable by a sensor installed on a road or outside a road side, the subject vehicle position can also be recognized by communicating with such a sensor via the communication unit 7.

The exterior environment recognition unit 14 recognizes an external situation in the surroundings of the subject vehicle, based on the signal from the external sensor group 1 such as a LiDAR, a radar, and a camera. For example, a position, a speed, and acceleration of a surrounding vehicle (a forward vehicle or a rearward vehicle) traveling in the surroundings of the subject vehicle, a position of a surrounding vehicle stopped or parked in the surroundings of the subject vehicle, and positions and states of other objects are recognized. The other objects include a sign, a traffic light, a road, a building, a guardrail, a utility pole, a signboard, a pedestrian, a bicycle, and the like. Indications such as division lines (such as white lines) and stop lines on a road surface are also included in the other objects (roads). The states of the other objects include a color (red, green, or yellow) of a traffic light, a moving speed and a direction of a pedestrian or a bicycle, and the like. Some of the stationary object among the other objects constitutes a landmark serving as an index of the position on the map, and the exterior environment recognition unit 14 also recognizes the position and type of the landmark.

The action plan generation unit 15 generates a driving path (a target path) of the subject vehicle from a current point of time to a predetermined time ahead, based on, for example, the target route calculated by the navigation unit 6, the map information stored in the memory unit 12, the subject vehicle position recognized by the subject vehicle position recognition unit 13, and the external environment recognized by the exterior environment recognition unit 14. In a case where there are a plurality of paths to be candidates for the target path on the target route, the action plan generation unit 15 selects, from among the plurality of paths, an optimal path that satisfies criteria such as compliance with laws and regulations and efficient and safe driving, and sets the selected path as the target path. Then, the action plan generation unit 15 generates an action plan corresponding to the target path that has been generated. The action plan generation unit 15 generates various action plans corresponding to driving modes, such as overtaking driving for overtaking a preceding vehicle, lane change driving for changing driving lanes, follow driving for following a preceding vehicle, lane keep driving for keeping the lane not to deviate from the driving lane, deceleration driving, or acceleration driving. In generating the target path, the action plan generation unit 15 first determines a driving mode, and then generates a target path, based on the driving mode.

In the self-drive mode, the driving control unit 16 controls each of the actuators AC so that the subject vehicle travels along the target path generated by the action plan generation unit 15. More specifically, in consideration of a driving resistance determined by a road gradient or the like in the self-drive mode, the driving control unit 16 calculates requested driving force for obtaining target acceleration per unit time that has been calculated by the action plan generation unit 15. Then, for example, the actuator AC is feedback-controlled so that actual acceleration that has been detected by the internal sensor group 2 becomes the target acceleration. More specifically, the actuator AC is controlled so that the subject vehicle travels at a target vehicle speed and the target acceleration. In the manual drive mode, the driving control unit 16 controls each of the actuators AC in accordance with a travel command (steering operation or the like) from the driver that has been acquired by the internal sensor group 2.

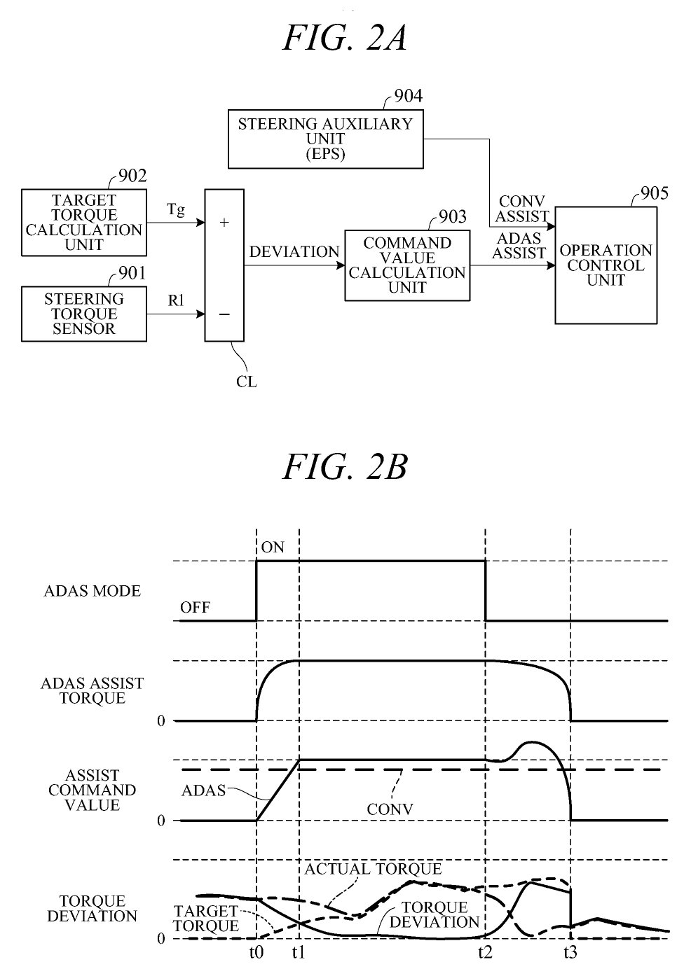

When the steering control by a lane keeping assist system (LKAS) is started, by the way, a rapid increase in assist output may give an occupant an uncomfortable feeling. FIGS. 2A and 2B each are a diagram for describing a rapid change in the assist output that occurs at the time of starting and ending the steering control by the LKAS. FIG. 2A illustrates one example of a configuration of a system (hereinafter, referred to as a conventional system configuration) mounted on a vehicle including the LKAS and electric power steering (EPS).

A steering torque sensor 901 in FIG. 2A detects the torque that works on the steering shaft in accordance with the steering angle of the steering wheel, that is, the steering torque. A target torque calculation unit 902 calculates an angle between an advancing direction of the vehicle and an extending direction of the driving lane, based on data acquired by an in-vehicle sensor such as a camera. The target torque calculation unit 902 calculates a target value (hereinafter, referred to as target steering torque or simply referred to as target torque) Tg of the steering torque, based on the calculated angle, so that the vehicle travels in the center of the driving lane. A calculator CL calculates a deviation amount (torque deviation (= Tg - Rl)) of the target torque relative to a detection value (hereinafter, referred to as actual steering torque or actual torque) Rl of the steering torque sensor 901, and outputs a calculation result.

A command value calculation unit 903 adjusts an auxiliary torque amount for the steering actuator. More specifically, the command value calculation unit 903 calculates an auxiliary torque amount for the steering actuator so as to make the torque deviation output from the calculator CL zero, that is, to maintain the traveling position of the subject vehicle in the center position in the driving lane. The command value calculation unit 903 outputs an electric current command value (referred to as an ADAS assist command value, or simply referred to as ADAS assist) corresponding to a calculated auxiliary torque amount. Note that, for example, PID control is used for adjusting the auxiliary torque amount by the command value calculation unit 903.

A steering auxiliary unit 904 has an EPS function of assisting the steering operation of the driver. The steering auxiliary unit 904 calculates an auxiliary torque amount in accordance with the steering operation of the driver, specifically, the steering angle of the steering wheel obtained by the steering operation, and outputs an electric current command value (referred to as a Conv assist command value, or simply referred to as Conv assist) corresponding to the calculated auxiliary torque amount.

An operation control unit 905 outputs torque based on the ADAS assist that has been input from the command value calculation unit 903 and the Conv assist that has been input from the steering auxiliary unit 904 to the steering actuator to control the steering of the vehicle. Specifically, the operation control unit 905 outputs the ADAS assist and the Conv assist to an assist motor (not illustrated) to actuate the assist motor. The assist motor outputs torque (hereinafter, referred to as assist torque) to the steering actuator, based on the ADAS assist and the Conv assist, to assist the steering of the vehicle. The Conv assist is output to the assist motor regardless of provision or absence of the driving assist by the LKAS. On the other hand, the ADAS assist is output to the assist motor while the driving assist by the LKAS is being performed.

Upon receipt of an instruction to provide the driving assist by the LKAS (hereinafter, referred to as an LKAS start instruction), the operation control unit 905 gradually increases the output ratio of the ADAS assist (hereinafter, referred to as an ADAS gain) that has been input from the command value calculation unit 903 from 0 to 1. Thus, the steering control conducted by the operation control unit 905 is gradually switched from steering control for providing the EPS function (hereinafter, referred to as Conv steering control) to steering control for providing the LKAS function (hereinafter, referred to as ADAS steering control). Hereinafter, this processing will be referred to as fade-in processing. On the other hand, upon receipt of an instruction to end the driving assist by the LKAS (hereinafter, referred to as an LKAS end instruction), the operation control unit 905 gradually decreases the ADAS gain from 1 to 0. Thus, the steering control conducted by the operation control unit 905 is gradually switched from the ADAS steering control to the Conv steering control. Hereinafter, this processing will be referred to as fade-out processing.

FIG. 2B is a diagram illustrating one example of a change in the ADAS assist torque at the time of starting and ending the ADAS (LKAS). The ADAS assist torque denotes assist torque to be output from the assist motor, based on the ADAS assist. When an LKAS start instruction is input (time t0), the operation control unit 905 performs the above fade-in processing (time t0 to t1). However, as illustrated in FIG. 2B, when the LKAS start instruction is input in a state in which there is a deviation between the target torque and the actual torque, the command value calculation unit 903 determines that the torque deviation has rapidly increased, and the ADAS assist output from the command value calculation unit 903 increases. As a result, the ADAS assist torque rapidly increases at time t0. In this manner, in the conventional system configuration of FIG. 2A, when the driving assist by the LKAS is started, the ADAS assist torque rapidly increases, and an unintended vehicle behavior may give an occupant an uncomfortable feeling. Note that in FIG. 2B, an ADAS mode flag is set to ON (1) when an ADAS start instruction is input, and is set to OFF (0) when an ADAS end instruction is input. Note that the initial value of the ADAS mode flag is OFF (0).

When the LKAS end instruction is input (time t2), the operation control unit 905 performs the above fade-out processing (time t2 to t3). However, the ADAS assist torque is reduced by the fade-out processing, then the reaction force for maintaining the traveling position of the vehicle in the center of the lane is weakened, and the torque deviation increases at time t2 and later, as illustrated in FIG. 2B. For this reason, the ADAS assist output from the command value calculation unit 903 increases, and the ADAS assist torque is less likely to decrease. As a result, the ADAS assist torque rapidly decreases just before the fade-out processing ends (time t3). In this manner, in the conventional system configuration of FIG. 1, also when the driving assist by the LKAS ends, an unintended vehicle behavior may give an occupant an uncomfortable feeling. Therefore, in the present embodiment, the driving control apparatus is configured as follows to deal with the above problems that occur at the time of starting and ending the driving assist by the LKAS.

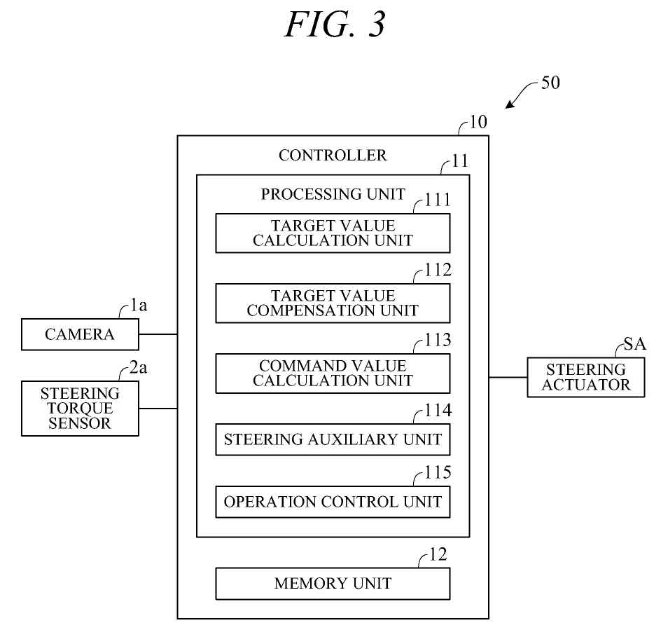

FIG. 3 is a block diagram of a configuration of main components of a driving control apparatus 50 according to the present embodiment. Such a driving control apparatus 50 constitutes a part of the vehicle control system 100 illustrated in FIG. 1. As illustrated in FIG. 3, the driving control apparatus 50 includes a controller 10, a camera 1a, a steering torque sensor 2a, and a steering actuator SA.

The camera 1a is a monocular camera including an imaging element, and constitutes a part of the external sensor group 1 in FIG. 1. The camera 1a may be a stereo camera. The camera 1a is mounted at a predetermined position, for example, in a front part of the subject vehicle, and continuously images a space on a forward side of the subject vehicle to acquire an image (a camera image) of a target object. The target object includes a division line or the like that defines a lane on a road. Note that the target object may be detected by a radar, a LiDAR, or the like instead of the camera 1a or together with the camera 1a. The steering torque sensor 2a detects a steering operation by the driver, more specifically, steering torque that works on the steering wheel. The steering torque sensor 2a constitutes a part of the internal sensor group 2 in FIG. 1.

The controller 10 in FIG. 3 includes a target value calculation unit 111, a target value compensation unit 112, a command value calculation unit 113, a steering auxiliary unit 114, and an operation control unit 115 as functional configurations fulfilled by the processing unit 11 (FIG. 1). In addition, the controller 10 includes the memory unit 12. The target value calculation unit 111, the target value compensation unit 112, the command value calculation unit 113, the steering auxiliary unit 114, and the operation control unit 115 constitute a part of the driving control unit 16. Note that the target value calculation unit 111, the target value compensation unit 112, and the command value calculation unit 113 may be configured as a part of the action plan generation unit 15.

The target value calculation unit 111 calculates an angle between the advancing direction of the subject vehicle and the extending direction of the lane in which the subject vehicle is traveling, based on a captured image of the camera 1a, and calculates a target value (target steering torque) Tg of the steering torque so that the subject vehicle travels in the center of the driving lane, based on such an angle. For the calculation of the target steering torque Tg, in addition to the captured image of the camera 1a, a detection value of a vehicle speed sensor, a detection value of a steering angle sensor, a detection value of a yaw rate sensor, and the like are also used.

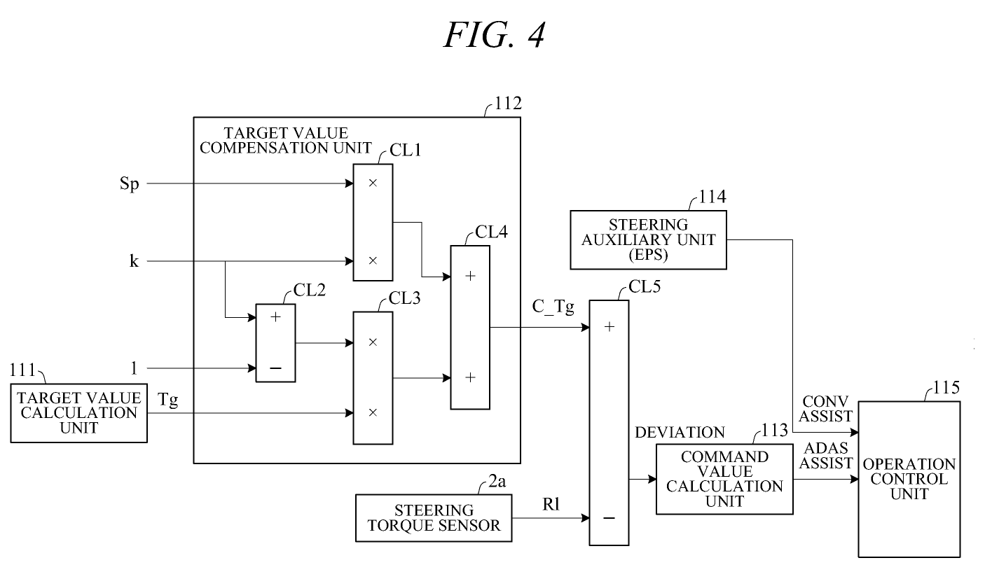

The target value compensation unit 112 compensates the target steering torque Tg that has been calculated by the target value calculation unit 111, and calculates compensated target steering torque (hereinafter, also simply referred to as compensated target torque) C_Tg. Here, the target value compensation unit 112 will be described in detail with reference to FIG. 4. FIG. 4 is a diagram for describing a system configuration of the driving control apparatus 50.

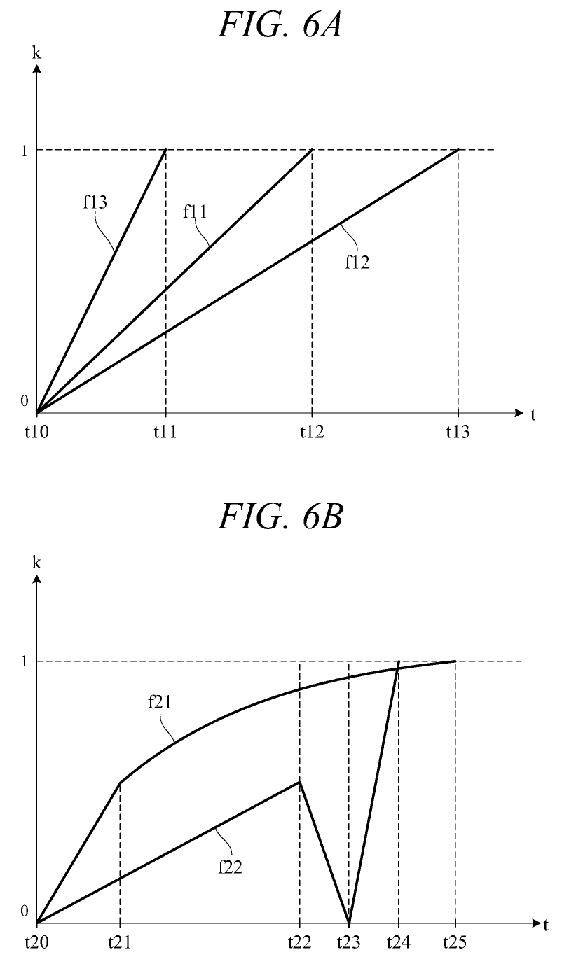

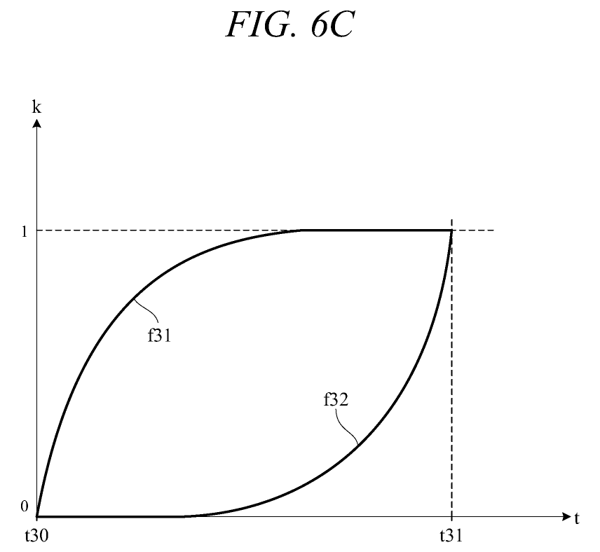

First, the target value compensation unit 112 acquires, from the target value calculation unit 111, the target steering torque Tg that has been calculated by the target value calculation unit 111. The target value compensation unit 112 acquires, from the steering auxiliary unit 114, a specific control parameter (hereinafter, referred to as an auxiliary component) Sp for use in the EPS function of the steering auxiliary unit 114. The auxiliary component Sp is, for example, a control parameter related to a steering angle or a control parameter related to the steering torque. In addition, the target value compensation unit 112 reads a map of a weight coefficient (hereinafter, also referred to as a ratio) k stored in the memory unit 12. The ratio k is a value equal to or larger than 0 and equal to or smaller than 1. The map of the ratio k (hereinafter, referred to as a ratio map) will be described later with reference to FIGS. 6A to 6C.

In the target value compensation unit 112, the auxiliary component Sp and the ratio k are input into a calculator (a multiplier) CL1. A multiplication result (Sp × k) by the multiplier CL1 is input into a calculator (an adder) CL4. Note that when the driving assist by the LKAS is not performed, the target value compensation unit 112 sets the ratio k to 1. When the driving assist by the LKAS is performed, the target value compensation unit 112 sets the ratio k to 0. When the LKAS start instruction is input and the fade-in processing is started, the target value compensation unit 112 gradually decreases the value of the ratio k from 1 to 0, based on the ratio map, as the time elapses from the start of the fade-in processing. On the other hand, when an LKAS end instruction is input and the fade-out processing is started, the target value compensation unit 112 gradually increases the value of the ratio k from 0 to 1, based on the ratio map, as the time elapses from the start of the fade-out processing.

In addition, in the target value compensation unit 112, the target steering torque Tg and a subtraction result obtained by subtracting the ratio k from 1 (1 - k) by a calculator (a subtractor) CL2 are input into a multiplier CL3. A multiplication result (Tg × (1 - k)) of the multiplier CL3 is input into the adder CL4. The target value compensation unit 112 inputs an addition result ((Sp × k) + (Tg × (1 - k))) of the adder CL4 into a calculator (a subtractor) CL5 as compensated target steering torque C_Tg. The subtractor CL5 subtracts a sensor value (actual torque) Rl of the steering torque sensor 2a from the compensated target steering torque C_Tg, and outputs a subtraction result (C_Tg - Rl) as a torque deviation.

The command value calculation unit 113 adjusts an auxiliary torque amount for the steering actuator SA. More specifically, the command value calculation unit 113 calculates an auxiliary torque amount for the steering actuator SA so as to make the torque deviation that has been output from the subtractor CL5 zero, and outputs an electric current command value (an ADAS assist) corresponding to the calculated auxiliary torque amount. Note that, for example, PID control is used for adjusting the auxiliary torque amount by the command value calculation unit 113.

Since the steering auxiliary unit 114 and the operation control unit 115 are respectively similar to the steering auxiliary unit 904 and the operation control unit 905 in FIG. 2A, their descriptions will be omitted.

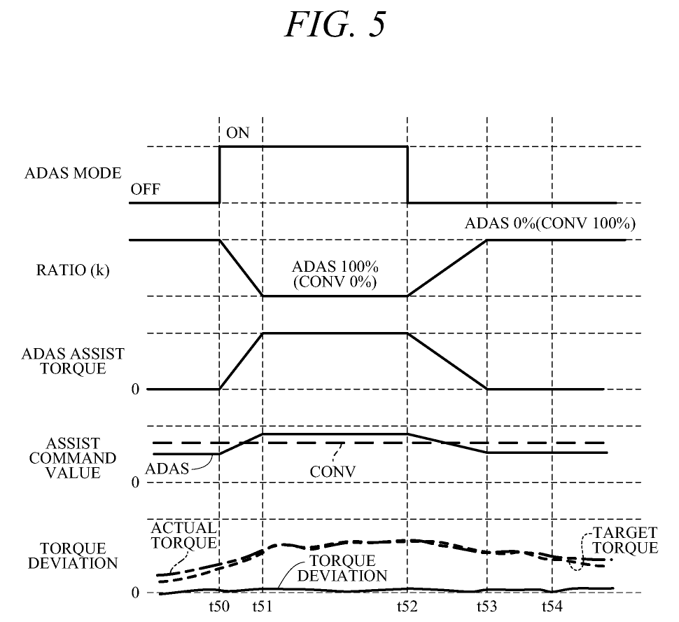

FIG. 5 is a diagram for describing compensation of the target steering torque Tg by the target value compensation unit 112. When the ADAS mode is OFF, the target value compensation unit 112 compensates the target steering torque Tg that has been calculated by the target value calculation unit 111, based on the ratio k to which 1 is set and the auxiliary component Sp acquired from the steering auxiliary unit 114, and calculates compensated target steering torque C_tg (= Tg × Sp). In this manner, when the ADAS mode is OFF, the target steering torque Tg is compensated, based on the auxiliary component Sp for use in the EPS function, and it becomes possible to reduce the torque deviation at the time of inputting the LKAS start instruction (time t50), as illustrated in FIG. 5. Thus, it becomes possible to suppress the rapid increase in the ADAS assist immediately after the LKAS start instruction is input as illustrated in FIG. 2B.

In addition, while the fade-in processing is being performed (time t50 to t51), the target value compensation unit 112 gradually reduces the value of the ratio k in accordance with an increase in the ADAS gain, and it becomes possible to keep the torque deviation small at time t50 and later as illustrated in FIG. 5. Thus, it becomes possible to increase the ADAS assist torque at a constant change rate in the fade-in processing, so that an occurrence of an unintended vehicle behavior as described above can be suppressed.

Furthermore, while the fade-out processing is being performed (time t52 to t53), the target value compensation unit 112 gradually increases the value of the ratio k in accordance with a decrease in the ADAS gain. Thus, it becomes possible to suppress an increase in the torque deviation in the fade-out processing that is illustrated in FIG. 2B, and to reduce the ADAS assist torque at a constant change rate. In this manner, also in the fade-out processing, the occurrence of the unintended vehicle behavior as described above can be suppressed.

FIGS. 6A to 6C each are a diagram for describing a ratio map. FIG. 5 illustrates an example in which the ratio k changes at a constant change rate in the fade-in processing (time t50 to t51) and the fade-out processing (time t52 to t53). However, as illustrated in FIG. 6A, the magnitude of the change rate of the ratio k may be changed in accordance with a driving state of the subject vehicle or an external situation (such as a curve of a road).

A characteristic f11 in FIG. 6A illustrates one example of the ratio k applied to the fade-out processing that is started while the subject vehicle is traveling on a straight road, that is, advancing straight ahead. A characteristic f12 indicates one example of the ratio k applied to the fade-out processing that is started while the subject vehicle is traveling on a curved road, that is, turning. While the subject vehicle in the lane keep driving in accordance with the LKAS function is traveling on a curved road, if the fade-out processing similar to that while traveling on a straight road is performed, there is a possibility that the subject vehicle might be swung to the outside of the curved road. Hence, in order to suppress such a vehicle behavior, as indicated by the characteristic f12, an inclination (a change rate) of the ratio k corresponding to a curved road may be made smaller than the ratio k corresponding to a straight road that is indicated by the characteristic f11.

In addition, the inclination of the ratio k may be changed in accordance with a curvature of the curved road. More specifically, as the curvature of the curved road is larger, the inclination of the ratio k may be made smaller. Further, in an emergency, for example, when a division line is not recognizable, based on a camera image or the like, or when an obstacle is recognized on a driving lane, based on the camera image or the like, it is desirable to promptly switch from the ADAS steering control to the Conv steering control. Then, in such an emergency, as indicated by a characteristic f13, the inclination of the ratio k may be made larger than that in a non-emergency (the characteristic f11 and the characteristic f12).

In addition, as illustrated in FIG. 6B, while the fade-out processing is being performed, the ratio k may be changed in accordance with a change in the driving state of the subject vehicle or the external situation. A characteristic f21 in FIG. 6B illustrates one example of the ratio k applied when the curvature of the driving lane of the subject vehicle changes (increases) while the fade-out processing is being performed. After the fade-out processing starts at time t20, in a case where the curvature of the driving lane in which the subject vehicle is traveling increases at time t21, if the fade-out processing is continuously performed while maintaining the inclination (the change rate) of the ratio before and at time t21, the subject vehicle may deviate from the driving lane. For this reason, in order to suppress such a vehicle behavior, the inclination of the ratio k may be changed in accordance with a change in the curvature of the driving lane at time t21 and later, as indicated by a characteristic f21. Specifically, the inclination of the ratio k may be gradually made gentle in accordance with a curvature of the driving lane that gradually increases.

In addition, while the fade-out processing is being performed, when an emergency situation such as a case where the subject vehicle is about to deviate from the driving lane occurs (time t22), the fade-in processing is performed to return to the ADAS steering control (time t22 to t23) as indicated by a characteristic f22. After an avoidance behavior from the emergency situation ends, the fade-out processing is performed again (time t23 to t24). Also in such a case, if the fade-in processing and the fade-out processing are performed (time t22 to t23 and time t23 to t24) as described above while maintaining the inclination (the change rate) of the ratio before and at time t22, it will not be possible to promptly shift the control to the Conv steering control. For this reason, the inclination of the ratio k applied to the fade-in processing and the fade-out processing performed when an emergency occurs may be made larger than that before the occurrence of the emergency (time t20 to t22), as indicated by a characteristic f22.

Furthermore, as illustrated in FIG. 6C, the magnitude of the change rate of the ratio k may be changed to correspond to a driver’s preference. For example, for drivers who desire to promptly switch the steering control, an exponentially increasing ratio k as indicated by a characteristic f31 may be applied to the fade-out processing. Thus, after the LKAS end instruction is input, it becomes possible to fade out the ADAS steering control all at once. For drivers who give importance to ease of handling at the time of switching the steering control, a logarithmically increasing ratio k as indicated by a characteristic f32 may be applied to the fade-out processing. Thus, after the LKAS end instruction is input, it becomes possible to fade out the ADAS steering control slowly, and the driver is able to deal with the end of the driving assist by the LKAS with enough time.

Although the examples of adjusting the ratio k applied to the fade-out processing have been described with reference to FIGS. 6A, 6B, and 6C, the adjustment of the ratio k as illustrated in FIGS. 6A, 6B, and 6C, may be applied to the fade-in processing.

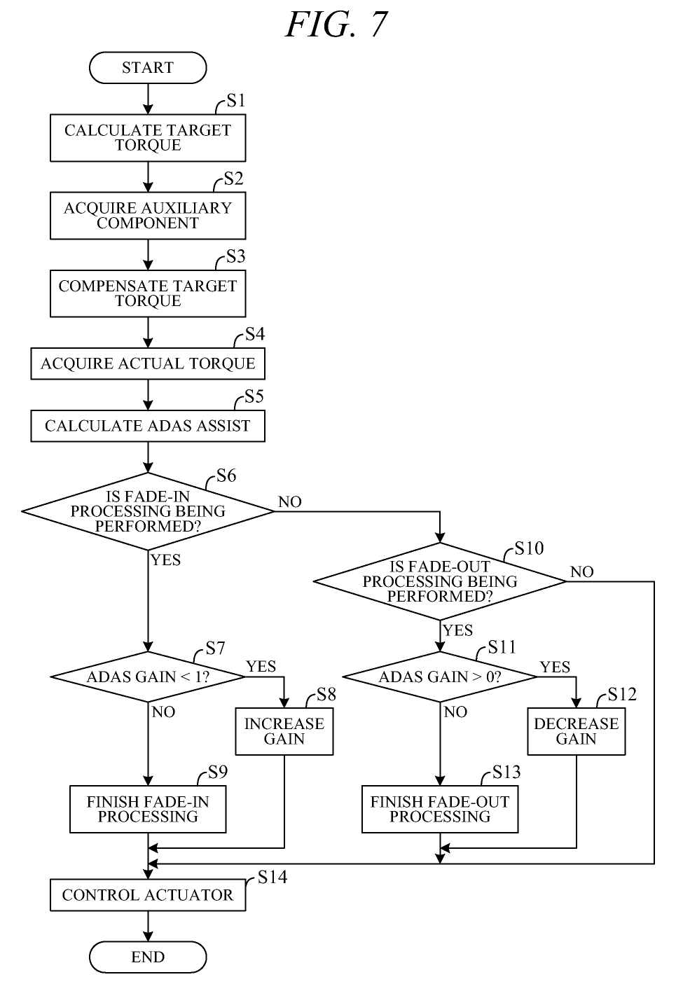

FIG. 7 is a flowchart illustrating one example of processing performed by the CPU of the controller 10 in FIG. 3 in accordance with a predetermined program. The processing illustrated in such a flowchart is performed, for example, at a predetermined cycle while the subject vehicle is traveling.

In step S1, the target steering torque Tg is calculated, based on the image captured by the camera 1a. In step S2, the auxiliary component Sp for use in the EPS function (the steering auxiliary unit 114) is acquired. In step S3, the target steering torque Tg is compensated using the auxiliary component Sp acquired in step S2 and the ratio k, and the compensated target steering torque C_Tg is calculated. Note that as described above, when the driving assist by the LKAS is not performed, 1 is set to the ratio k. When the driving assist by the LKAS is performed, 0 is set to the ratio k.

In step S4, a sensor value (actual torque) Rl of the steering torque sensor 2a is acquired. In step S5, the auxiliary torque amount for the steering actuator SA is calculated so that the deviation amount (the torque deviation) between the compensated target steering torque C_Tg calculated in step S3 and the actual torque Rl acquired in step S4 becomes zero. Furthermore, an electric current command value (the ADAS assist) corresponding to the calculated auxiliary torque amount is calculated.

In step S6, it is determined whether the fade-in processing is being performed. In a case where an affirmative determination is made in step S6, whether the ADAS gain is smaller than 1 is determined in step S7. In a case where an affirmative determination is made in step S7, the ADAS gain is increased by a predetermined amount in step S8. In addition, the ratio k is decreased, based on the ratio map stored in the memory unit 12 and the elapsed time from the start of the fade-in processing. In a case where a negative determination is made in step S7, the fade-in processing ends in step S9.

On the other hand, in a case where a negative determination is made in step S6, whether the fade-out processing is being performed is determined in step S10. In a case where an affirmative determination is made in step S10, whether the ADAS gain is larger than 0 is determined in step S11. In a case where an affirmative determination is made in step S11, the ADAS gain is decreased by a predetermined amount in step S12. In addition, the ratio k is increased, based on the ratio map stored in the memory unit 12 and the elapsed time from the start of the fade-in processing. In a case where a negative determination is made in step S11, the fade-out processing ends in step S13.

In step S14, the ADAS assist calculated in step S5 is output to the assist motor in accordance with the ADAS gain. Specifically, a value obtained by multiplying the ADAS assist by the ADAS gain is output to the assist motor. Furthermore, the Conv assist that has been output from the EPS function (the steering auxiliary unit 114) is output to the assist motor. The assist motor outputs the assist torque to the steering actuator SA, based on the ADAS assist in which the ADAS gain is multiplied, and the Conv assist.

Note that, in steps S8 and S12, out of the plurality of ratio maps stored in the memory unit 12, a ratio map corresponding to an external situation that has been recognized, based on the captured image of the camera 1a, or the driving state of the subject vehicle that has been recognized, based on the sensor value of the vehicle speed sensor, the acceleration sensor, or the like is used. For example, in a case where the driving lane of the subject vehicle is a straight line, the ratio map of the characteristic f11 illustrated in FIG. 6A is read from the memory unit 12, and is used in step S12. In addition, out of the plurality of ratio maps stored in the memory unit 12, a ratio map that has been selected beforehand, based on a user’s operation, may be read from the memory unit 12, and may be used.

According to the embodiments of the present invention, the following operation and effects are achievable.

(1) The driving control apparatus 50 includes: the operation control unit 115 configured to control at least a part of operation of a moving body, based on a command value; the command value calculation unit 113 as a deviation match unit configured to compare a target operation value of the operation with an actual operation value, and to calculate a command value to be input into the operation control unit 115 so as to make the actual operation value close to the target operation value; the steering auxiliary unit 114 as a manual operation assist unit configured to assist the manual operation of an occupant; and the target value compensation unit 112 as a compensation unit configured to compensate the target operation value of the operation. The operation control unit 115, as a control switch unit, switches operation control for controlling at least a part of the operation of the moving body between operation control based on a command value and operation control by manual operation of an occupant. The target value compensation unit 112 compensates the target operation value using an auxiliary component of the steering auxiliary unit 114, and calculates a compensated target operation value. The command value calculation unit 113 compares the compensated target operation value with the actual operation value, and calculates a command value.

In this manner, the target steering torque is compensated using an output component related to manual operation assistance such as the EPS. Then, while the command value for the control of the operation of the moving body is calculated, based on a comparison result (a deviation) between the compensated target steering torque and the actual torque, the operation control based on the command value and the operation control by the manual operation of the occupant are switched. Therefore, it becomes possible to switch the operation control in consideration of the deviation amount based on the manual operation assistance, so that an unintended vehicle behavior at the time of switching can be suppressed.

(2) The target value compensation unit 112 calculates a compensated target operation value using an auxiliary component compensated value obtained by compensating an auxiliary component of the steering auxiliary unit 114 and an adjusted target operation value obtained by adjusting the target operation value. In this situation, the target value compensation unit 112 calculates an auxiliary component compensated value (Sp × k) by multiplying the auxiliary component (Sp) by a predetermined coefficient (k), which is a value between 0 and 1, and calculates an adjusted target operation value (Tg × (1 - k)) by multiplying the target operation value (Tg) by a value (1 - k), which is obtained by subtracting a predetermined coefficient from 1. Thus, the compensated target operation value can be calculated with accuracy.

(3) When the operation control unit 115 starts the operation control based on the command value, the target value compensation unit 112 gradually decreases the predetermined coefficient from 1 as the time elapses from the control start time. In this situation, the target value compensation unit 112 decreases the predetermined coefficient in accordance with a predetermined change rate. Thus, an unintended vehicle behavior that may occur at the time of switching from the Conv steering control to the ADAS steering control can be suppressed in a more reliable manner.

(4) When the operation control unit 115 ends the operation control based on the command value, the target value compensation unit 112 gradually increases the predetermined coefficient from 0 as the time elapses from the control end time. In this situation, the target value compensation unit 112 increases the predetermined coefficient in accordance with a predetermined change rate. Thus, an unintended vehicle behavior that may occur at the time of switching from the ADAS steering control to the Conv steering control can be suppressed in a more reliable manner.

The above embodiments may be modified into various embodiments. Hereinafter, modifications will be described. In the above embodiment, the driving control apparatus 50 is applied to a self-driving vehicle. However, the driving control apparatus 50 is also applicable to any other types of vehicles. For example, the driving control apparatus 50 is also applicable to manual driving vehicles each equipped with an advanced driver-assistance systems (ADAS).

In addition, in the above embodiment, the command value calculation unit 113 as the deviation match unit compares the target steering torque as the target operation value with the actual steering torque as the actual operation value, calculates an ADAS assist command value that makes the deviation (the torque deviation) between the actual steering torque and the target steering torque zero, and inputs the ADAS assist command value into the operation control unit 115. However, when the operation of the subject vehicle controlled by the operation control unit 115 is another type of operation other than steering, the deviation match unit may calculate an ADAS assist command value that makes the deviation between the target operation value and the actual operation value corresponding to such another type of operation zero, and may input the ADAS assist command value into the operation control unit 115.

The above embodiment can be combined as desired with one or more of the aforesaid modifications. The modifications can also be combined with one another.

According to the present invention, the steering control can be smoothly switched.

Above, while the present invention has been described with reference to the preferred embodiments thereof, it will be understood, by those skilled in the art, that various changes and modifications may be made thereto without departing from the scope of the appended claims.

What is claimed is:

1. A driving control apparatus comprising a microprocessor and a memory connected to the microprocessor, wherein
the microprocessor is configured to perform:
comparing a target operation value of a predetermined operation of a moving body with an actual operation value,
calculating a command value used for controlling the operation so as to bring the actual operation value closer to the target operation value, and
controlling the operation based on the command value, wherein
the microprocessor is configured to further perform:
calculating a corrected target operation value by correcting the target operation value using an assist component of an assist function in which manual operation for the operation by an occupant is assisted, and
comparing the corrected target operation value with the actual operation value to calculate the command value.

2. The driving control apparatus according to claim 1, wherein
the microprocessor is configured to perform
the calculating of the corrected target operation value including calculating the corrected target operation value using an assist component correction value obtained by correcting the assist component and an adjusted target operation value obtained by adjusting the target operation value.

3. The driving control apparatus according to claim 2, wherein
the microprocessor is configured to perform
the calculating of the corrected target operation value including calculating the assist component correction value by multiplying the assist component by a predetermined coefficient, the predetermined coefficient being a value between 0 and 1, and calculating the adjusted target operation value by multiplying the target operation value by a value obtained by subtracting the predetermined coefficient from 1.

4. The driving control apparatus according to claim 3, wherein
the moving body is configured to be switchable between a first function in which the operation is controlled by manual operation of the occupant and a second function in which the operation is controlled based on the command value, and
the microprocessor is configured to perform
the calculating of the corrected target operation value including gradually decreasing the predetermined coefficient from 1 according to elapsed time from a control start time when control of the operation based on the command value by the second function is started.

5. The driving control apparatus according to claim 4, wherein
the microprocessor is configured to perform
the calculating of the corrected target operation value including decreasing the predetermined coefficient according to a predetermined rate of change.

6. The driving control apparatus according to claim 3, wherein
the moving body is configured to be switchable between a first function in which the operation is controlled by manual operation of the occupant and a second function in which the operation is controlled based on the command value, and
the microprocessor is configured to perform
the calculating of the corrected target operation value including, when control of the operation based on the command value by the second function is terminated, gradually increasing the predetermined coefficient from 0 according to elapsed time from a control termination time.

7. The driving control apparatus according to claim 6, wherein
the microprocessor is configured to perform
the calculating of the corrected target operation value including increasing the predetermined coefficient according to a predetermined rate of change.

8. The driving control apparatus according to claim 1, further comprising
a steering actuator, wherein
the operation is steering, and
the microprocessor is configured to further perform
outputting a torque based on the command value to the steering actuator to control steering of the moving body.
